(19) United States
(12) Patent Application Publication
(10) Pub. No.: US 2019/0215500 A1
(43) Pub. Date: Jul. 11, 2019

(54) PROJECTION CONTROL APPARATUS AND PROJECTION CONTROL METHOD

(71) Applicant: CANON KABUSHIKI KAISHA, Tokyo (JP)

(72) Inventor: Masaharu Yamagishi, Yokohama-shi (JP)

(21) Appl. No.: 16/244,182

(22) Filed: Jan. 10, 2019

(30) Foreign Application Priority Data
Jan. 11, 2018 (JP) 2018-002960

(51) Int. Cl. H04N 9/31; G06T 7/70

(52) U.S. Cl. CPC H04N 9/3185; H04N 9/3147; H04N 9/3191; H04N 9/3188; G06T 7/70

(57) ABSTRACT

A projection system includes a first projection apparatus, a second projection apparatus, and a control apparatus. The control apparatus includes a first communication unit that communicates with the first projection apparatus, a second communication unit that communicates with the second projection apparatus, and an acquisition unit that acquires a shift amount between a projection position of the first projection apparatus and a projection position of the second projection apparatus, and a generation unit that generates image data to be output to the first projection apparatus and image data to be output to the second projection apparatus from input image data, on the basis of the shift amount.

### BACKGROUND OF THE INVENTION

### Field of the Invention

The present invention relates to techniques for controlling pixel shifting in multi-screen projection.

### Description of the Related Art

Display devices that display high-resolution images having higher resolutions than in the past are becoming widespread in recent years. Among such high-resolution images, images having 3840 pixels in the horizontal direction and 2160 pixels in the vertical direction, for example, are typically called “4K images”. The development of ultra-high-definition display systems having 8K resolutions (7680 horizontal pixels×4320 vertical pixels) is also progressing, and higher resolutions are being implemented for video content as well. In light of such trends, 8K resolution display devices are being developed in parallel with 4K resolution display devices.

Meanwhile, pixel shifting techniques are known as techniques for improving spatial resolutions. Such techniques divide a frame image into a plurality of field images in accordance with a shift amount, and display the field images with the projection positions of the pixels shifted sequentially by ½, which makes it possible to realize a resolution higher than the native resolution of the display element. In other words, a plurality of field images are generated on the basis of pixel shifting positions from the single frame image, in the field images are displayed sequentially in accordance with the pixel positions to improve the apparent resolution (Japanese Patent Laid-Open No. 2011-203460). There are also techniques that improve spatial resolution by using a plurality of projectors and spatially shifting the projection positions thereof by ½ pixel and then combining the images (Japanese Patent Laid-Open No. 2006-145933).

However, when using these past techniques for multi-screen projection, which uses a plurality of projectors, it is difficult to accurately project the display images at positions shifted by ½ pixel. Thus there is a problem in that when combining and displaying images on a projection plane, the ideal result of displaying the pixels shifted by ½ cannot be achieved, and the pixels will instead be displayed as shifted from the ideal position. This results in step-shaped lines being visibly recognizable as jaggies.

### SUMMARY OF THE INVENTION

The present invention has been made in consideration of the aforementioned problems, and provides an image projection system that, in pixel shifting control used in multi-screen projection, makes it possible to achieve both an increase in resolution through pixel shifting and a reduction in jaggies.

In order to solve the aforementioned problems, the present invention provides a projection control apparatus comprising: a first communication unit configured to communicate with a first projection apparatus; a second communication unit configured to communicate with a second projection apparatus; and at least one processor and/or at least one circuit to perform the operations of the following units: an acquisition unit configured to acquire a shift amount between a projection position of the first projection apparatus and a projection position of the second projection apparatus; and a generation unit configured to generate image data to be output to the first projection apparatus and image data to be output to the second projection apparatus from input image data, on the basis of the shift amount.

In order to solve the aforementioned problems, the present invention provides a projection system comprising: a first projection apparatus; a second projection apparatus; and a control apparatus, wherein the control apparatus includes: a first communication unit configured to communicate with the first projection apparatus; a second communication unit configured to communicate with the second projection apparatus; and at least one processor and/or at least one circuit to perform the operations of the following units: an acquisition unit configured to acquire a shift amount between a projection position of the first projection apparatus and a projection position of the second projection apparatus; and a generation unit configured to generate image data to be output to the first projection apparatus and image data to be output to the second projection apparatus from input image data, on the basis of the shift amount.

In order to solve the aforementioned problems, the present invention provides a projection control method of a projection control apparatus comprising a first communication unit configured to communicate with a first projection apparatus and a second communication unit configured to communicate with a second projection apparatus, the method comprising: acquiring a shift amount between a projection position of the first projection apparatus and a projection position of the second projection apparatus; and generating image data to be output to the first projection apparatus and image data to be output to the second projection apparatus from input image data, on the basis of the shift amount.

In order to solve the aforementioned problems, the present invention provides a non-transitory computer-readable storage medium storing a program for causing a computer to execute a projection control method of a projection control apparatus, the apparatus comprising a first communication unit configured to communicate with a first projection apparatus and a second communication unit configured to communicate with a second projection apparatus, and the method comprising: acquiring a shift amount between a projection position of the first projection apparatus and a projection position of the second projection apparatus; and generating image data to be output to the first projection apparatus and image data to be output to the second projection apparatus from input image data, on the basis of the shift amount.

According to the present invention, in pixel shifting control used in multi-screen projection, it is possible to achieve both an increase in resolution through pixel shifting and a reduction in jaggies.

Further features of the present invention will become apparent from the following description of exemplary embodiments (with reference to the attached drawings).

### BRIEF DESCRIPTION OF THE DRAWINGS

FIG. 1 is a block diagram illustrating a system according to a first embodiment.

FIG. 2 is a diagram illustrating pixel positions in projection images from projectors according to the first embodiment.

FIG. 3 is a block diagram illustrating the configuration of a PC according to the first embodiment.

FIGS. 4A and 4B are block diagrams illustrating examples of test patterns according to the first embodiment.

FIG. 5 is a diagram illustrating an example of positional relationships when a shift amount for projection images is an ideal amount, according to the first embodiment.

FIG. 6 is a diagram illustrating an example of positional relationships when the shift amount for projection images is not an ideal amount, according to the first embodiment.

FIG. 7 is a diagram illustrating an example of sampling phases when the shift amount for projection images is an ideal amount, according to the first embodiment.

FIG. 8 is a diagram illustrating an example of sampling phases when the shift amount for projection images is not an ideal amount, according to the first embodiment.

FIG. 9 is a diagram illustrating an interpolation method for sampling phases when the shift amount for projection images is not an ideal amount, according to the first embodiment.

FIG. 10 is a block diagram illustrating a system according to a second embodiment.

FIG. 11 is a block diagram illustrating the configuration of a projector according to the second embodiment.

FIG. 12 is a flowchart illustrating operations according to the second embodiment.

FIGS. 13A to 13D are diagrams illustrating pixel shifting control in projectors according to the second embodiment.

FIGS. 14A and 14B are diagrams illustrating an example of sampling phases when the shift amount for projection images is an ideal amount and not an ideal amount, according to the second embodiment.

FIG. 15 is a diagram illustrating an example of sampling phases when the shift amount for projection images is an ideal amount, according to the second embodiment.

FIGS. 16A and 16B are diagrams illustrating an example of sampling phases when the shift amount for projection images is an ideal amount and not an ideal amount, according to the second embodiment.

FIG. 17 is a diagram illustrating an interpolation method for sampling phases when the shift amount for projection images is not an ideal amount, according to the second embodiment.

FIG. 18 is a block diagram illustrating a system according to a third embodiment.

FIG. 19 is a block diagram illustrating the configuration of a PC according to a fourth embodiment.

FIGS. 20A and 20B are diagrams illustrating examples of filter coefficients according to the fourth embodiment.

### DESCRIPTION OF THE EMBODIMENTS

Embodiments of the present invention will be described in detail below. The following embodiments are merely examples for practicing the present invention. The embodiments should be properly modified or changed depending on various conditions and the structure of an apparatus to which the present invention is applied. The present invention should not be limited to the following embodiments. Also, parts of the embodiments to be described later may be properly combined.

Note that the respective function blocks described in the embodiments do not necessarily have to be implemented as individual pieces of hardware. In other words, the functions of some of the function blocks may be executed by a single piece of hardware, for example. Conversely, the function of a single function block or the functions of a plurality of function blocks may be executed by several pieces of hardware operating in tandem. Additionally, the functions of the function blocks may be executed by computer programs loaded into memory by a CPU.

### First Embodiment

An image projection system according to a first embodiment will be described below.

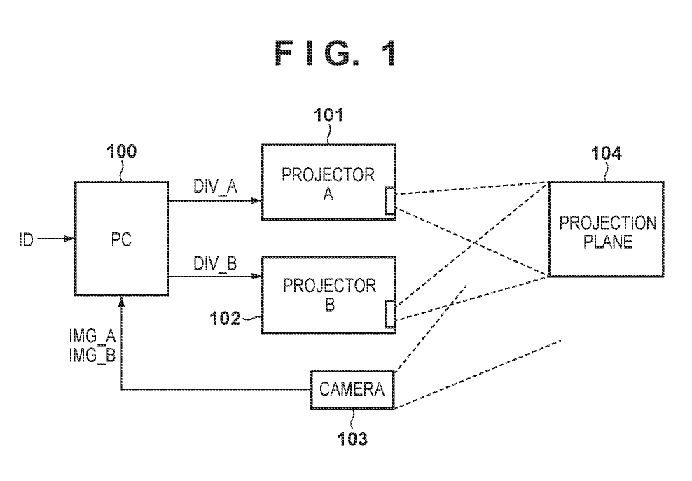

FIG. 1 illustrates an example of the configuration of the image projection system according to the present embodiment.

As illustrated in FIG. 1, the image projection system according to the present embodiment includes a personal computer (PC) 100, a projector A101, a projector B102, a camera 103, and a projection plane 104. A high-resolution image ID is input to the PC 100. The input image ID is assumed to be an image having a resolution of 4K, 8K, or the like, for example.

The PC 100 is an image output apparatus that, by subjecting the input image ID to reduction division in accordance with the resolutions of the projectors, generates reduced-division images DIV_A and DIV_B to be projected by the projectors A101 and B102, respectively. The reduced-division images DIV_A and DIV_B are 2K resolution images, for example, and are images in which the pixel positions are shifted by a predetermined shift amount, e.g., an amount equivalent to a fraction of a pixel (½ (0.5) pixel), from each other. An image that appears as having a 4K or 8K resolution due to the pixel shifting effect can be displayed by having the projector A101 and the projector B102 display the reduced-division images DIV_A and DIV_B on the projection plane 104 with the pixel positions thereof shifted by the predetermined shift amount.

The projector A101 is a projection apparatus that projects the reduced-division image DIV_A, which has been generated by the PC 100, onto the projection plane 104. Although the projector A101 includes a display panel based on a predetermined projection technique such as the DLP technique or the LCOS technique, the projector is not limited to these techniques, and another technique may be used instead.

The projector B102 is a projection apparatus that projects the reduced-division image DIV_B, which has been generated by the PC 100, onto the projection plane 104. The projector B102 also has a display panel based on the same predetermined projection technique as the projector A101. Note that it is desirable that the projector A101 and the projector B102 be the same model.

The camera 103 is an image capture apparatus that captures an image of the projection plane 104. The camera 103 generates a captured image IMG_A by capturing an image of a projection image (test pattern) from the projector A101, and a captured image IMG_B by capturing an image of a projection image (test pattern) from the projector B102. The captured images IMG_A and IMG_B captured by the camera 103 are sent to the PC 100.

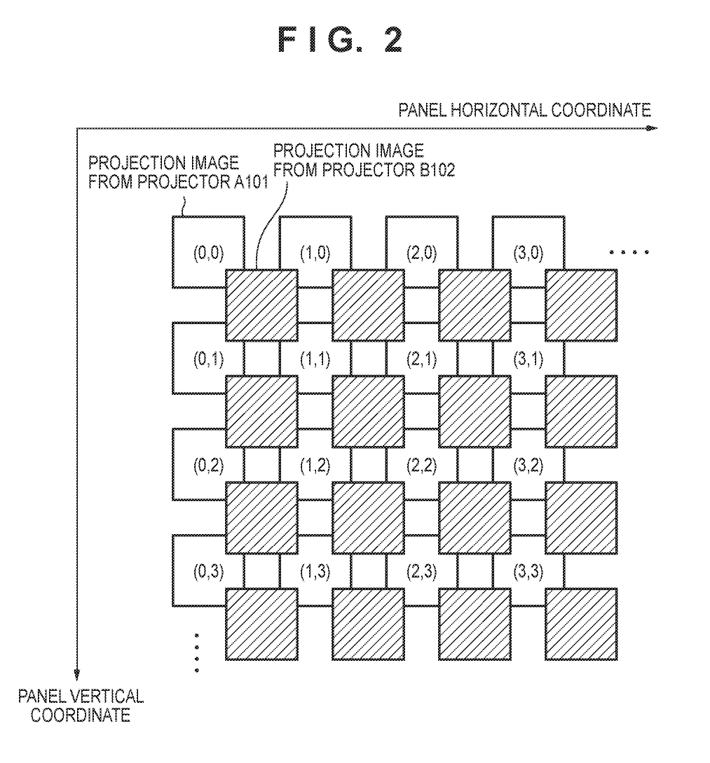

The projection image from the projector A101 and the projection image from the projector B102 are displayed on the projection plane 104 in an overlapping manner. FIG. 2 illustrates a relationship between the pixel positions of the respective projection images from the projector A101 and the projector B102 in the case of an ideal shift amount, where the pixel positions of the respective projection images are shifted by 0.5 pixels in a horizontal direction and a vertical direction orthogonal to each other. The quadrangles in FIG. 2 represent the pixel positions in the projection images from the projector A101 and the projector B102. As indicated in FIG. 2, the projection image from the projector A101 (the group of pixels represented by the white squares) and the projection image from the projector B102 (the group of pixels represented by the hatched squares) are projected at positions shifted from each other by 0.5 pixels in the horizontal direction and the vertical direction.

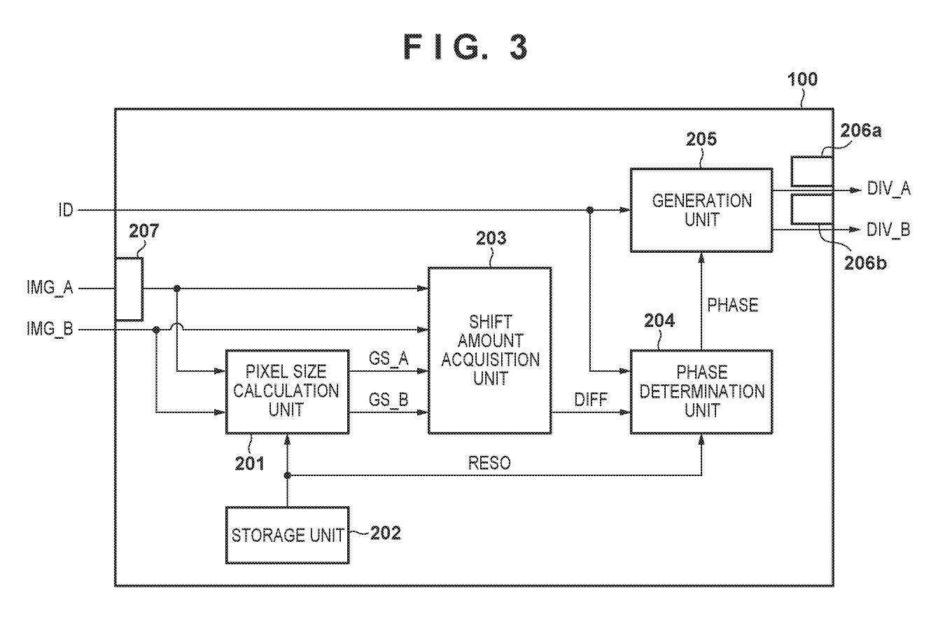

The configuration and functions of the PC 100 will be described next with reference to FIG. 3. The PC 100 includes a pixel size calculation unit 201, a storage unit 202, a shift amount acquisition unit 203, a phase determination unit 204, a generation unit 205, communication units 206a and 206b, and an input unit 207. The input unit 207 is a circuit that communicates with the camera 103 and inputs the captured images IMG_A and IMG_B, which will be described later.

The pixel size calculation unit 201 calculates a projection pixel size GS_A of the projection image projected by the projector A101, for when the image is projected onto the projection plane 104, on the basis of a resolution of the display panel (a panel resolution) RESO stored in the storage unit 202 and the captured image IMG_A captured by the camera 103. Likewise, the pixel size calculation unit 201 calculates a projection pixel size GS_B of the projection image projected by the projector B102, for when the image is projected onto the projection plane 104, on the basis of the captured image IMG_B. The projection pixel sizes are constituted by horizontal direction sizes GS_A_H and GS_B_H, and vertical direction sizes GS_A_V and GS_B_V. The projection pixel sizes are values expressing the length of a single pixel on the projection plane 104 in terms of the number of pixels in the captured images IMG_A and IMG_B.

The panel resolution RESO is defined by horizontal direction pixel number RESO_H and a vertical direction pixel number RESO_V. For example, with an FHD display panel (1920 horizontal pixels×1080 vertical pixels), the horizontal direction pixel number RESO_H is 1920, and the vertical direction pixel number RESO_V is 1080.

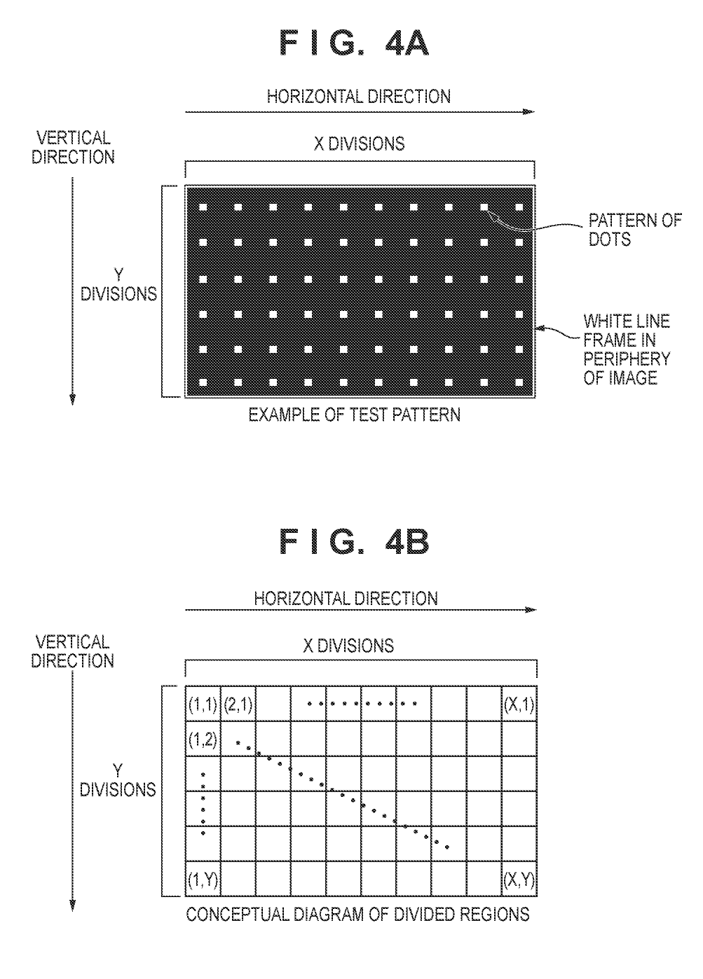

The captured images IMG_A and IMG_B captured by the camera 103 are images in which the test patterns generated within the respective projectors have been projected onto the projection plane 104. FIGS. 4A and 4B illustrate examples of the test patterns. The test pattern illustrated in FIG. 4A includes a dot pattern, with one horizontal pixel and one vertical pixel located at the vertices of each of divided regions obtained when a display region is divided into X horizontal division regions and Y vertical division regions, as well as a white line frame located in the display boundary of the display region. X and Y are integer numbers determined in accordance with the number of divisions. In other words, a white frame is displayed in the periphery of the display region, and a pattern of dots equivalent to the number of X×Y divided regions is displayed. In the present embodiment, a pattern of (X−1)×(Y−1) dots is displayed. FIG. 4B is a conceptual diagram of the display region.

A method of calculating the projection pixel sizes GS_A_H, GS_B_H, GS_A_V, and GS_B_V will be described next.

First, a length HA of the horizontal direction sides and a length VA of the vertical direction sides of the captured image IMG_A on the projection plane are calculated from the white line frame included in the test pattern in the captured image IMG_A. Likewise, a length HB of the horizontal direction sides and a length VB of the vertical direction sides of the captured image IMG_B on the projection plane are calculated from the white line frame included in the test pattern in the captured image IMG_B. Using these values, the projection pixel sizes are calculated through the following Expressions 1 and 2.

GS_A_H=HA/RESO_H (Expression 1)

GS_A_V=VA/RESO_V (Expression 2)

Note that GS_B_H and GS_B_V are also calculated in the same manner using Expressions 1 and 2.

Using the two captured images IMG_A and IMG_B input from the camera 103 and the pixel sizes GS_A and GS_B calculated by the pixel size calculation unit 201, the shift amount acquisition unit 203 acquires a shift amount DIFF between the display panel coordinates of the two captured images. The shift amount DIFF is a value that is calculated for each divided region, and is 0.5 pixels when the pixel positions of the projection images from the two projectors are at an ideal shift amount.

In the present embodiment, the shift amount DIFF is calculated for the dot positions indicating the vertices of each divided region in the test pattern. Here, although increasing the number of divisions X and Y for the divided regions increases the precision when generating the reduced-division images, doing so also increases the scale of the hardware involved in image processing, and thus the number of region divisions is determined in light of processing speed and the like.

The shift amount DIFF calculated by the shift amount acquisition unit 203 includes a horizontal direction shift amount HDIFF of the projector B102 relative to the projector A101 and a vertical direction shift amount VDIFF of the projector B102 relative to the projector A101. Both of these are calculated in units of 0.1 pixels, and express the shift amounts in units of the pixels in the display panel.

A method for calculating the shift amount DIFF will be described next.

The shift amount DIFF can be calculated from a shift amount between the projection positions of the dot patterns of the respective projectors, for each divided region. In the following descriptions, N and M represent indices expressing coordinates for each region, and n and m represent indices expressing coordinates in units of pixels.

DOT_A_H[N][M] represents the horizontal coordinate values of the dot pattern within the captured image IMG_A, and DOT_B_H[N][M] represents the horizontal coordinate values of the dot pattern within the captured image IMG_B. Likewise, DOT_A_V[N][M] represents the vertical coordinate values of the dot pattern within the captured image IMG_A, and DOT_B_V[N][M] represents the vertical coordinate values of the dot pattern within the captured image IMG_B. DOT_A_H[N][M] can be acquired from the captured image IMG_A. Also, DOT_B_H[N][M] can be calculated from the captured image IMG_B in the same manner. The coordinate values in each dot pattern are calculated at a precision of 0.1 pixels.

Using DOT_A_H[N][M] and DOT_B_H[N][M], the horizontal direction shift amount HDIFF is calculated through the following Expression 3.

HDIFF[N][M]=(DOT_A_H[N][M]−DOT_B_H[N][M])/GS_B_H (Expression 3)

The calculations are similar for the vertical direction, and are made using the following Expression 4.

VDIFF[N][M]=(DOT_A_V[N][M]−DOT_B_V[N][M])/GS_B_V (Expression 4)

The shift amounts DIFF[N][M] calculated for each region are mapped as shift amounts for each of the pixels. Specifically, a value can be calculated for each of the pixels through typical linear interpolation using the shift amount DIFF[N][M] in each region. DIFF(n,m) (where n is an integer of 0 to 1919 and m is an integer of 0 to 1079 when the panel resolution is FHD) are output to the phase determination unit 204.

On the basis of the input image ID, the panel resolution RESO, and the shift amount DIFF, the phase determination unit 204 determines pixel information, and a reduced sampling phase PHASE as an interpolation phase, to be used in thinning processing when the generation unit 205 generates the reduced-division images DIV_A and DIV_B.

The reduced sampling phase PHASE is obtained through the following Expression 5, using an input image resolution ID_RESO given to the input image ID, the panel resolution RESO, and the shift amount DIFF. The reduced sampling phase PHASE is a value calculated on a pixel-by-pixel basis.

PHASE(n,m)=ID_RESO/RESO×DIFF(n,m) (Expression 5)

In Expression 5, the shift amount DIFF is a parameter having values in the horizontal direction and the vertical direction, and thus the reduced sampling phase PHASE is constituted as a set of a horizontal direction parameter PHASE H(n,m) and a vertical direction parameter PHASE V(n,m).

On the basis of the reduced sampling phase PHASE, the generation unit 205 generates the reduced-division image DIV_A and/or the reduced-division image DIV_B from the input image ID, with the pixel positions shifted from each other by the predetermined shift amount. For example, the reduced-division image DIV_A is taken as a reference (with no shift), and the reduced-division image DIV_B, which is shifted by 0.5 pixels, is generated, in accordance with the value of the reduced sampling phase PHASE. The generation unit 205 outputs the images to the communication units 206a and 206b, respectively. The communication units 206 communicate with the respective projectors, and output the reduced-division images generated by the generation unit 205 to the corresponding projectors. The communication unit 206a communicates with the projector A101 and outputs the reduced-division image DIV_A. The communication unit 206b communicates with the projector B102 and outputs the reduced-division image DIV_B.

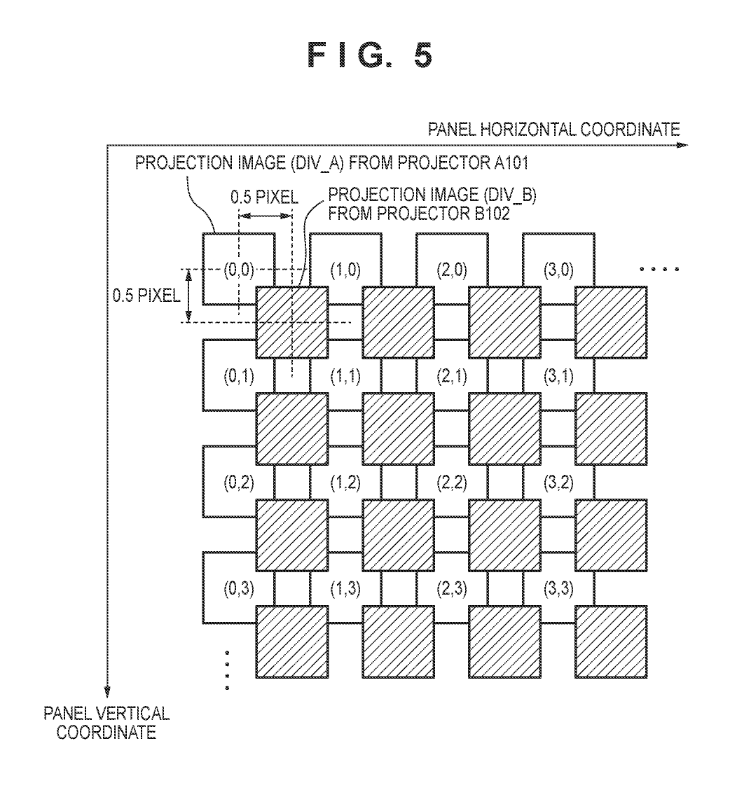

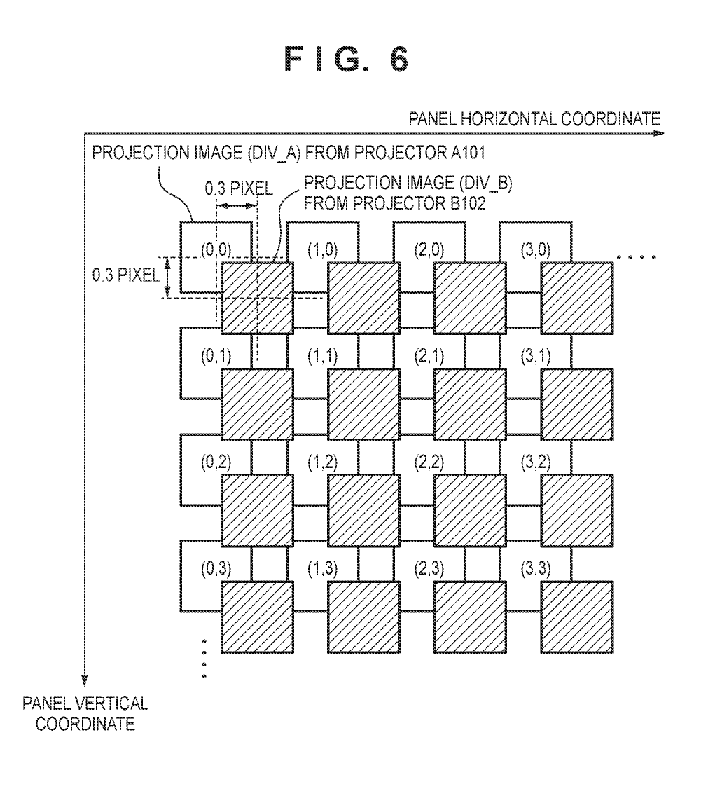

The processing by the generation unit 205 for generating the reduced-division images will be described next. FIG. 5 illustrates an example of the projection images when the shift amount between the reduced-division images DIV_A and DIV_B is an ideal amount (0.5 pixels). On the other hand, FIG. 6 illustrates an example of the projection images when the shift amount between the reduced-division images DIV_A and DIV_B is not an ideal amount (e.g., 0.3 pixels).

A method of generating the reduced-division images DIV_A and DIV_B will be described next. Note that the following descriptions assume that the resolution of the input image ID is twice the panel resolution.

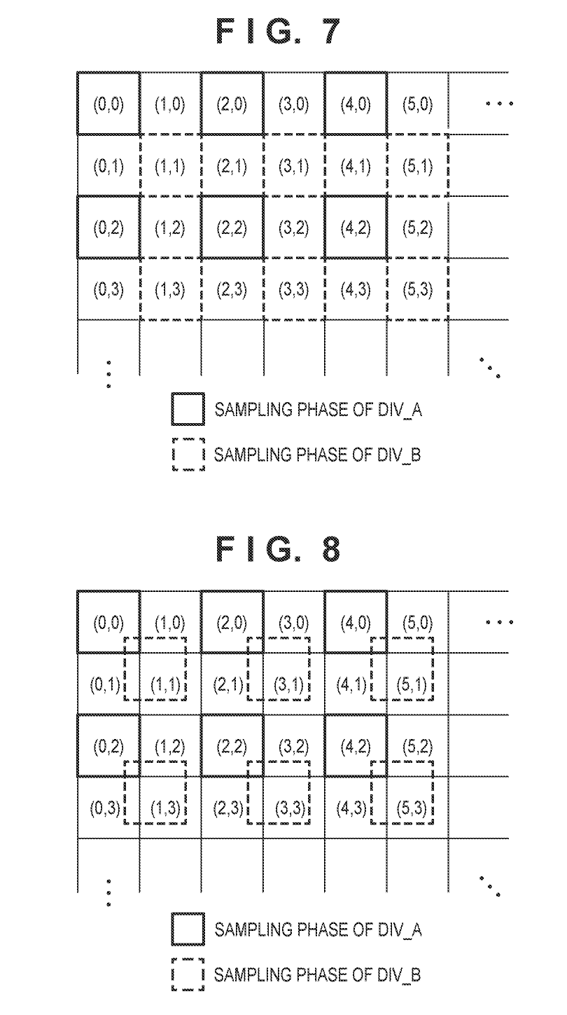

When the shift amount between the reduced-division images is an ideal amount as indicated in FIG. 5, the reduced sampling phase PHASE is, based on Expression 5, 1.0 (2×0.5) pixels. As such, both reduced-division images DIV_A and DIV_B can take the pixel values at the resolution of the input image ID as interpolation pixels directly, without employing filtering processing. FIG. 7 illustrates an example of the reduced-division images DIV_A and DIV_B in this case.

Next, a method for generating the reduced-division images DIV_A and DIV_B when the shift amount between the reduced-division images is not an ideal amount, as illustrated in FIG. 6, will be described using FIG. 8.

As illustrated in FIG. 8, the reduced-division image DIV_A takes the pixel values of the resolution of the input image ID directly as interpolation pixels. The reduced-division image DIV_B, however, uses pixel values from four peripheral locations centered on the interpolation pixels to carry out filtering processing, and uses the resultants as interpolation pixels (bilinear interpolation, put simply). In this case, the reduced sampling phase PHASE is 0.6 (=2×0.3) pixels. For example, the interpolation pixel corresponding to coordinates (1,1) in the reduced-division image DIV_B are at a position shifted by 0.6 pixels from the coordinates (2,2) in the input image ID, and the pixels at coordinates (2,2), (3,2), (2,3), and (3,3) can be obtained through linear interpolation.

By carrying out such processing, the interpolation pixels can be generated with respect to the input image ID, on the basis of accurate pixel positions where the projection images are projected by the projector A101 and the projector B102.

The foregoing descriptions assume that the reduced-division image DIV_B is uniformly shifted in the horizontal and vertical directions by 0.3 pixels relative to the reduced-division image DIV_A, and the reduced sampling phase PHASE is the same value for all regions. However, the configuration is not limited thereto. The reduced-division image DIV_B may be obtained by interpolating the input image ID according to reduced sampling phases PHASE obtained on a pixel-by-pixel basis.

An interpolation method using interpolation pixels when generating the reduced-division image DIV_B will be described next using FIG. 9.

As described with reference to FIGS. 7 and 8, the reduced-division image DIV_A takes the values of pixels located at coordinates where both the horizontal coordinates and the vertical coordinates are even numbers as the interpolation pixels. FIG. 9 illustrates a method for generating the reduced-division image DIV_B.

In FIG. 9, U1, U2, D1, and D2 indicate the pixel positions of actual pixels in the input image ID (before reduction). U1 corresponds to a reduction interpolation position of the reduced-division image DIV_A. P1, meanwhile, indicates a reduction interpolation position that takes into account the projection image from the projector A101 and the reduced sampling phase PHASE of the projection image from the projector B102. The reduction interpolation position P1 is obtained through linear interpolation using the actual pixels in the input image ID from four locations, that is, two rows and two columns, in the periphery of P1 (U1, U2, D1, and D2).

In FIG. 9, “ix_i” is an integer value expressing the horizontal position of the pixel in the input image ID, whereas “iy_i” is an integer value expressing the vertical position of the pixel in the input image ID. Additionally, “ix_s” is a fractional value expressing the horizontal position of the reduction interpolation position P1 from U1, and “iy_s” is a fractional value expressing the vertical position of the reduction interpolation position P1 from U1. For example, the coordinates of the reduction interpolation position P1 (horizontal position, vertical position) can be expressed as (ix_i+ix_s, iy_i+iy_s).

When the reduced sampling phase in the horizontal direction is represented by PHASE_H(n,m) and the reduced sampling phase in the vertical direction is represented by PHASE_V(n,m), these can be used to calculate the coordinate values of ix_s and iy_s, through the following Expressions 6 and 7.

ix_s=1−PHASE_H(n,m) (Expression 6)

iy_s=1−PHASE_V(n,m) (Expression 7)

A method of calculating the interpolation pixel value at the reduction interpolation position P1 will be described next.

An interpolation pixel value OD at the reduction interpolation position P1 is calculated through weighted synthesis of the pixel values of pixels U1, U2, D1, and D2 using weights “PHASE_H” and “PHASE_V” based on distance (that is, based on the distance from the interpolation position P1). PHASE_H represents a horizontal direction weight and PHASE_V represents a vertical direction weight.

The interpolation pixel value OD is calculated using Expression 8, indicated below. In Expression 8, “U1(ix_i,iy_i)” represents the pixel value of the pixel U1, “U2(ix_i+1, iy_i)” represents the pixel value of the pixel U2, “D1(ix_i, iy_i+1)” represents the pixel value of the pixel D1, and “D2(ix_i+1, iy_i+1)” represents the pixel value of the pixel D2.

OD=(U1(ix_i,iy_i)×PHASE_H+U2(ix_i+1,iy_i)×(1−PHASE_H))×PHASE_V+(D1(ix_i,iy_i+1)×PHASE H+D2(ix_i+1, iy_i+1)×(1−PHASE_H))×(1−PHASE_V) (Expression 8)

Values in which the interpolation pixel value OD has been calculated as indicated above for all the pixels are output as the reduced-division image DIV_B.

Although the present embodiment describes bilinear interpolation as an example, a higher-quality reduced-division image DIV_B can be generated if a different method is used (e.g., bicubic interpolation).

According to the present embodiment, when projection images from a plurality of projectors are projected with a predetermined shift amount between the images, reduced-division images can be generated by interpolating the pixel values on the basis of a difference from an ideal shift amount between the projection images of the projectors on the projection plane. As a result, in pixel shifting control used in multi-screen projection, it is possible to achieve both an increase in resolution through pixel shifting and a reduction in jaggies.

### Second Embodiment

A second embodiment will be described next.

The first embodiment describes an example where the projectors A101 and B102 do not include pixel shifting functions. As opposed to this, the present embodiment will describe an example in which the projectors include pixel shifting functions. Furthermore, the first embodiment describes an example in which the camera 103 is provided separate from the projectors A101 and B102. As opposed to this, the present embodiment will describe an example in which the projectors include image capturing units.

The following descriptions will focus upon the differences from the first embodiment.

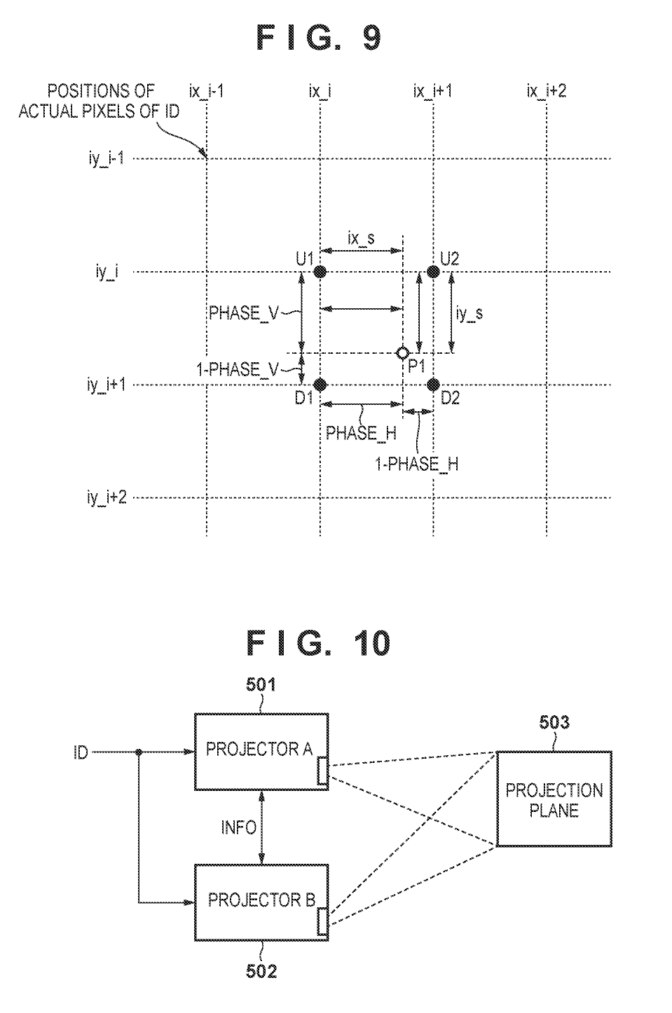

First, a system configuration according to the second embodiment will be described with reference to FIG. 10.

A projector A501 and a projector B502 include pixel shifting functions and image capturing functions, are connected to each other by a signal line, and exchange control information INFO. The control information INFO includes a timing control signal SIG and reference phase information DEF_PHASE. The system according to the present embodiment increases the resolution of a projection image by spatially shifting the projection positions of the projector A501 and the projector B502.

In the present embodiment, the projector A501 is set as a master projector, the projector B502 is set as a slave projector, and the projector A501, which serves as the master projector, primarily handles the control.

Next, the configurations and functions of the projectors A501 and B502 according to the present embodiment will be described with reference to FIG. 11, primarily in terms of the master projector, which primarily handles the control.

An image capturing unit 601 captures an image of a projection plane onto which a test pattern, generated by a test pattern generation unit 614, is projected. The test pattern is the same as that illustrated in FIGS. 4A and 4B, described in the first embodiment. IMG_A is an image of the projection plane captured when the projector A501 projects the test pattern, and IMG_B is an image of the projection plane captured when the projector B502 projects the test pattern.

A timing control unit 606 outputs a timing signal TSIG in accordance with a synchronization signal SYNC synchronized with the input image ID, and controls the operations of a selection unit 607, a panel unit 609, and a pixel shifting unit 610. The timing control unit 606 also generates the timing control signal SIG for use with the slave projector, and outputs that signal to the slave projector. The synchronization signal SYNC is constituted by a horizontal synchronization signal HSYNC and a vertical synchronization signal VSYNC. Using the vertical synchronization signal VSYNC synchronized with an input frame frequency, the timing signal TSIG is generated as a control signal having a framerate twice that of the input image. For example, when the input image is 60 Hz, the timing signal TSIG is generated at 120 Hz. In other words, the driving of the selection unit 607, the panel unit 609, and the pixel shifting unit 610 is controlled by the timing signal TSIG at a framerate twice the input frame frequency. As a result, for a 60 Hz input image, frame switching control is carried out at 120 Hz for the selection unit 607, the panel unit 609, and the pixel shifting unit 610.

The timing control signal SIG is sent to the image capturing unit 601, the pixel shifting unit 610, and the test pattern generation unit 614 to control the output and stopping of an image signal. When a timing signal of “0”, indicating “off”, is transmitted, the pixel shifting unit 610 stops pixel shifting control, a test pattern is projected from the test pattern generation unit 614, the image capturing unit 601 captures an image of the projection plane, and the captured image IMG_A is acquired. The timing control signal SIG is also sent to the slave projector to control the output and stopping of the image signal. When a timing signal of “1”, indicating “on”, has been sent, a test pattern projection instruction is sent to the slave projector, an image of the projection plane is captured by the image capturing unit 601, and the captured image IMG_B is acquired.

The selection unit 607 reads out the reduced-division images DIV_A and DIV_B in accordance with a predetermined timing signal TSIG designated by the timing control unit 606, and outputs these as a selected image SELD. The selection unit 607 reads out at speed twice the framerate of the input image ID. In other words, when DIV_A and DIV_B are 60 Hz, SELD is read out at 120 Hz.

A panel control unit 608 generates a voltage signal PD, for modulating a transmittance of the panel unit 609, on the basis of the reduced-division image signals DIV_A and DIV_B selected by the selection unit 607.

The panel unit 609 outputs image light PA corresponding to the input image ID to the pixel shifting unit 610 by causing light emitted from a light source unit 612 to be transmitted at the transmittance based on the voltage signal PD input from the panel control unit 608. The panel unit 609 also changes the transmittance in accordance with the timing signal TSIG.

The pixel shifting unit 610 projects the image light PA output from the panel unit 609 having shifted the image by 0.5 in the horizontal direction/vertical direction on a frame-by-frame basis. In this manner, the reduced-division image DIV_A (the white squares in FIG. 2) in the reduced-division image DIV_B (the hatched squares in FIG. 2), which are illustrated in FIG. 2, are displayed so as to be switched in an alternating manner, appearing to the human eye as having been combined in a timewise manner, which makes it possible to achieve a sense of a higher resolution than the panel resolution.

A light source control unit 611 transmits a control signal CON to the light source unit 612, which will be described later, on the basis of the selected image SELD selected by the selection unit 607, a user instruction made through an operation unit (not shown), and the like, and the light source unit 612 is turned on/off, the light amount thereof is controlled, and so on.

The light source unit 612 is a halogen lamp, a xenon lamp, a high-pressure mercury lamp, or the like, and irradiates the panel unit 609 with light on the basis of the control signal CON.

The image capturing timing of the image capturing unit 601 will be described next.

The image capturing timing of the image capturing unit 601 is determined on the basis of the timing control signal SIG exchanged between the projectors. The timing control signal SIG is generated by the timing control unit 606, and is transmitted to the image capturing unit 601, the pixel shifting unit 610, the test pattern generation unit 614, and the slave projector. Specifically, timing signals are generated for the timing at which to project or extinguish the test pattern, the timing at which the pixel shifting unit 610 is to turn pixel shifting control on or off, the timing at which the image capturing unit 601 captures an image, and the timing at which the test pattern generation unit 614 generates the test pattern. When the image capturing unit 601 is to capture an image, control is carried out so that the slave projector does not project.

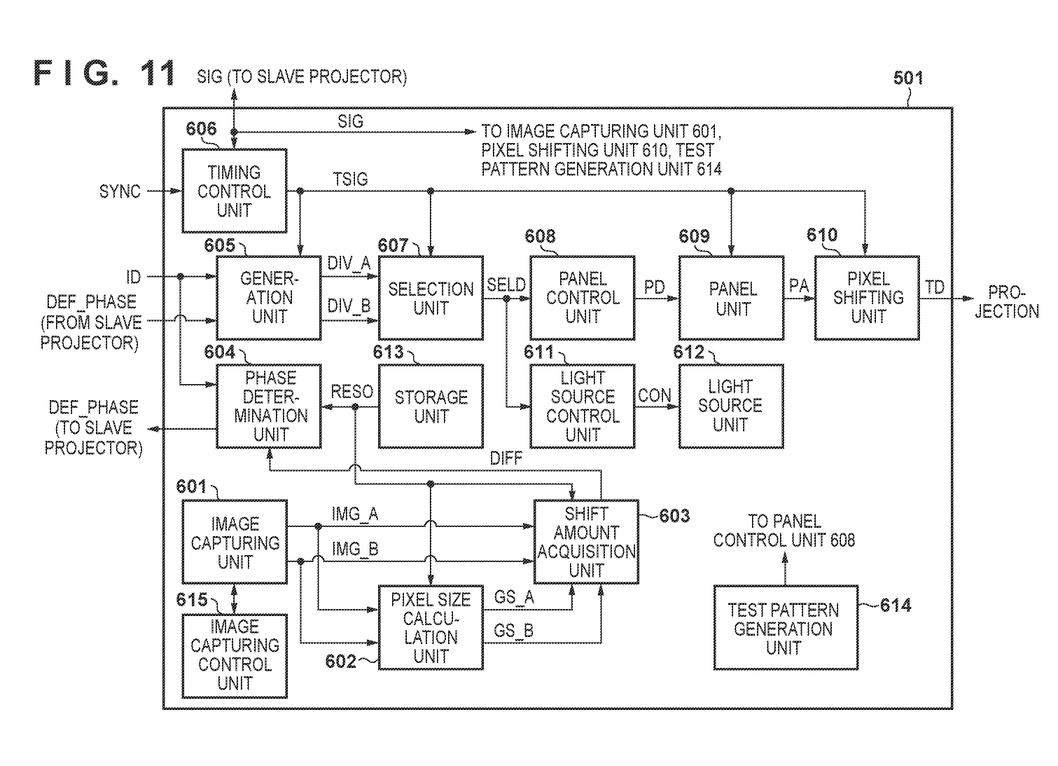

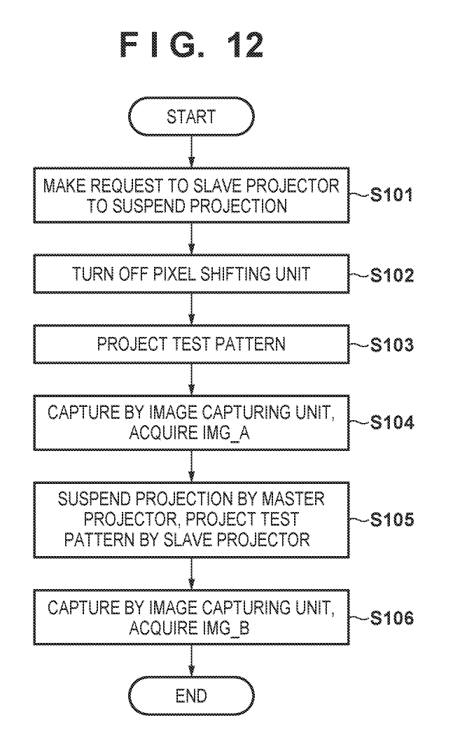

Processing for controlling the projectors in the system according to the present embodiment will be described next with reference to FIG. 12.

The processing illustrated in FIG. 12 is started when a user issues an instruction to carry out pixel shifting control to the projector A501, which is the master projector, using a remote controller (not illustrated), and is realized by the processors of the projectors executing programs stored in memory.

In S101, the timing control unit 606 requests that projection be suspended by sending the timing control signal SIG, which indicates that the “projection” is to be suspended, to the slave projector. The timing control unit 606 of the slave projector, which has received the transmitted timing control signal SIG, transmits the timing signal TSIG to the panel unit 609 in order to suspend the projection.

In S102, the timing control unit 606 turns the pixel shifting unit 610 off by sending a control signal SIG for turning the pixel shifting unit off to the pixel shifting unit 610.

In S103, the timing control unit 606 issues a test pattern generation instruction to the test pattern generation unit 614, and the test pattern is projected.

In S104, an image capturing control unit 615 issues an instruction to the image capturing unit 601, and the image capturing unit 601 captures an image of the projected test pattern so as to acquire the captured image IMG_A.

In S105, the timing control unit 606 issues an instruction to the panel unit 609, and suspends the projection of the master projector. The timing control unit 606 then issues a request to project the test pattern by sending the timing control signal SIG to the slave projector, and the slave projector then projects the test pattern.

In S106, the image capturing control unit 615 issues an instruction to the image capturing unit 601, and the image capturing unit 601 captures an image of the test pattern projected by the slave projector so as to acquire the captured image IMG_B.

By turning the pixel shifting unit 610 off when capturing the captured images IMG_A and IMG_B as described above, the pixel positions of the two projection images can be measured accurately for the purpose of calculating the shift amount between the projection images.

The basic operations of a pixel size calculation unit 602, a shift amount acquisition unit 603, and a storage unit 613 are the same as in the first embodiment.

A phase determination unit 604 calculates a reference phase information DEF_PHASE according to the second embodiment on the basis of the input image ID, a shift amount DIFF calculated by the shift amount acquisition unit 603, and the panel resolution RESO stored in the storage unit 613.

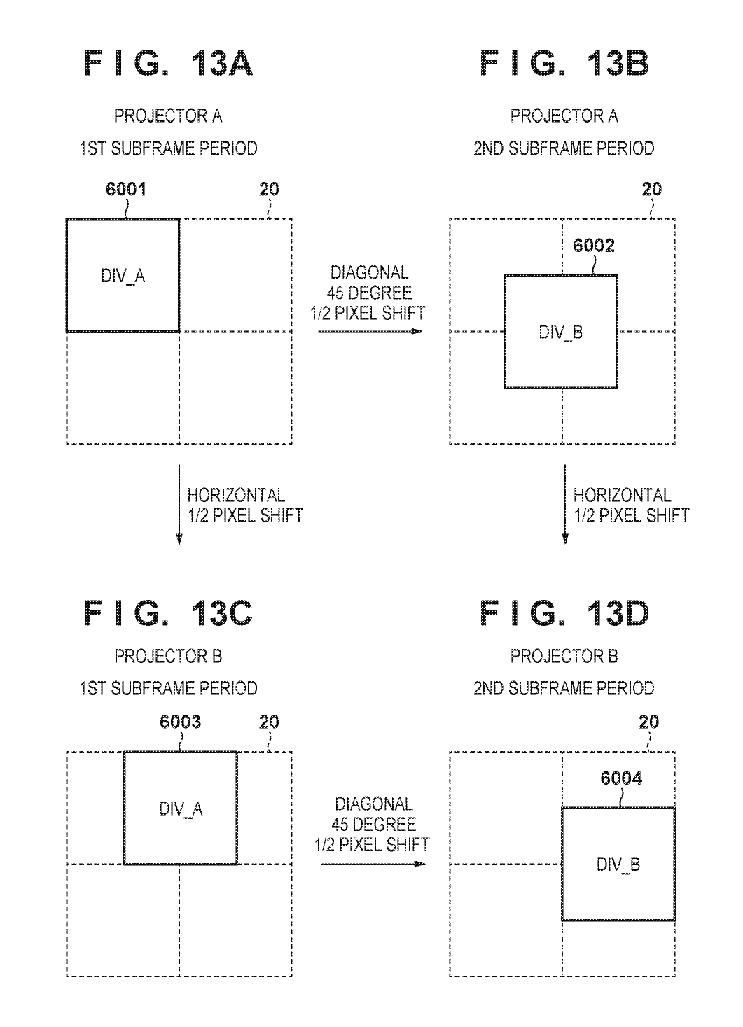

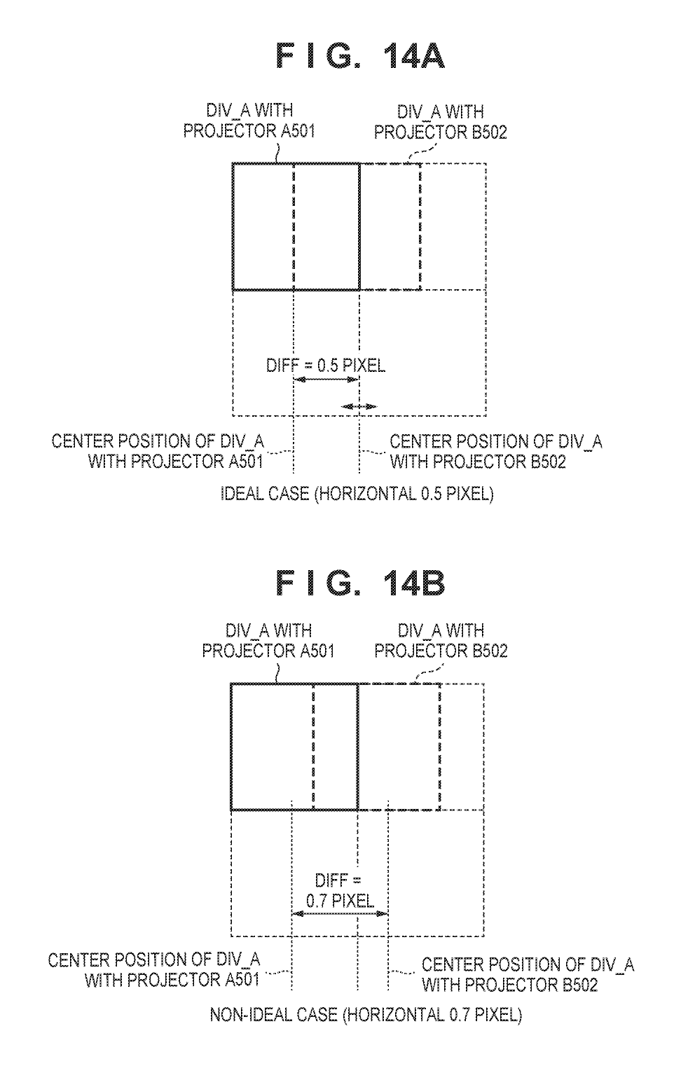

FIGS. 13A to 13D illustrate an example of the positional relationship between the projection images from the projector A501 and the projector B502. The first/second subframe periods in FIGS. 13A to 13D correspond to a first frame/second frame when the selection unit 607 reads out at 2× speed, which will be described later. FIG. 13A indicates a pixel position for display in the first subframe period by the projector A501. FIG. 13B indicates a position for display in the second subframe period by the projector A501. FIGS. 13A and 13B are in a positional relationship of being shifted in a direction corresponding to an angle of 45° (by 0.5 pixels in the horizontal direction and the vertical direction).

FIG. 13C indicates a pixel position for display in the first subframe period by the projector B502. FIG. 13D indicates a position for display in the second subframe period by the projector B502. FIGS. 13C and 13D are in a positional relationship of being shifted in a direction corresponding to an angle of 45° (by 0.5 pixels in the horizontal direction and the vertical direction).

As can be seen from FIGS. 13A to 13D, the projector A501 and the projector B502 are in a positional relationship of being shifted by ½ pixel in the horizontal direction. The projector A501 and the projector B502 project the reduced-division images with the pixels shifted in a direction corresponding to a 45° angle (by 0.5 pixels in the horizontal direction and the vertical direction) in frame order, and furthermore, the projectors A501 and B502 project the reduced-division images in the same frame having been shifted by the pixel shifting unit 610 by ½ pixel in the horizontal direction. By employing such multi-screen projection, an even greater increase in resolution can be achieved than when shifting the pixels in only a single projector.

The reference phase information DEF_PHASE is obtained through Expression 9, indicated below, using the input image resolution ID_RESO given to the input image ID, the panel resolution RESO, and the shift amount DIFF. Note that although these elements are denoted in a single dimension, the elements have values in both the horizontal and vertical directions (with the horizontal direction represented by DEF_PHASE_H and the vertical direction represented by DEF_PHASE_V). The reference phase information DEF_PHASE is a value calculated on a pixel-by-pixel basis. Additionally, an overview of the shift amount DIFF calculated by the shift amount acquisition unit 603 is indicated in FIGS. 14A and 14B.

DEF_PHASE(n,m)=ID_RESO/RESO×DIFF(n,m) (Expression 9)

In Expression 9, the reference phase information DEF_PHASE and the shift amount DIFF are parameters having different values from region to region, and are thus configured as matrices.

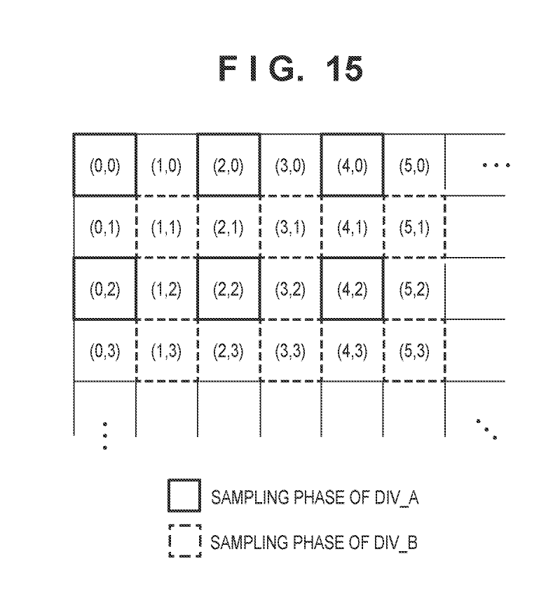

The basic operations of a generation unit 605 are the same as in the first embodiment, and thus only the differences will be described here. When a projector is designated as a master projector, the generation unit 605 generates the reduced-division image DIV_A and/or DIV_B in accordance with a predetermined reduced sampling phase, as illustrated in FIG. 15. On the other hand, when a projector is designated as a slave projector, the predetermined reduced sampling phase is corrected on the basis of the reference phase information DEF_PHASE acquired from the master projector.

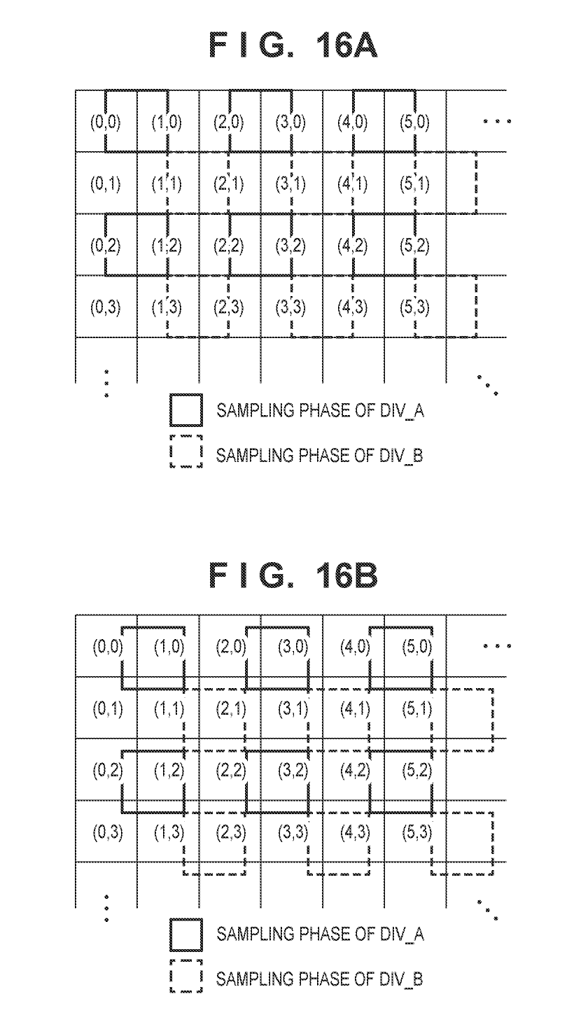

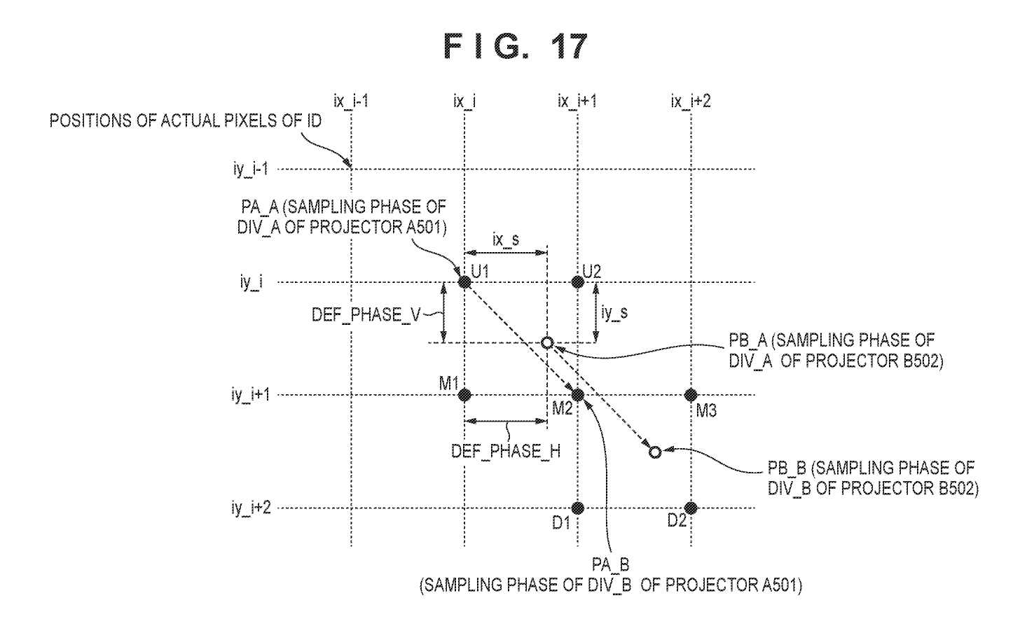

FIG. 16A illustrates an example where the reduced sampling phase is an ideal phase, whereas FIG. 16B illustrates an example where the reduced sampling phase is not an ideal phase. As illustrated in FIG. 16B, when the projection position of the projector B502 is shifted from the ideal shift amount, a reduced-division image projected at the ideal shift amount can be generated by correcting the reduced sampling phase on the basis of the reference phase information DEF_PHASE calculated from the shift amount DIFF between the projectors. The method of generating the reduced-division image will be described using FIG. 17.

A pixel position PA_A indicates the reduced sampling phase of the reduced-division image DIV_A of the projector A501, whereas a pixel position PA_B indicates the reduced sampling phase of the reduced-division image DIV_B of the projector A501. Likewise, a pixel position PB_A indicates the reduced sampling phase of the reduced-division image DIV_A of the projector B502, whereas a pixel position PB_B indicates the reduced sampling phase of the reduced-division image DIV_B of the projector B502.

The reference phase information DEF_PHASE_H and DEF_PHASE_V represent shift amounts from the position of the pixel position PB_A in the case where the pixel position PA_A in FIG. 17 is taken as a reference.

The reduced-division image DIV_A of the projector A501 takes a pixel value U1 directly as the reduced-division image. Meanwhile, the reduced-division image DIV_B of the projector A501 takes a pixel value M2, which is in a position shifted from the pixel value U1 by one pixel in the horizontal direction and one pixel in the vertical direction (corresponding to 0.5 pixels horizontally and vertically after ½ reduction), directly as the reduced-division image.

The reduced-division image DIV_A of the projector B502 takes a position shifted from the reduced-division image DIV_A of the projector A501 by DEF_PHASE_H in the horizontal direction and DEF_PHASE_V in the vertical direction (that is, the pixel position PB_A) as an interpolation position. The reduced-division image DIV_A of the projector B502 can be obtained through linear interpolation from the pixels in the periphery of the pixel position PB_A (U1, U2, M1, and M2). The calculation method is the same as in the first embodiment.

Additionally, the reduced-division image DIV_B of the projector B502 takes the pixel position PB_B, which is in a position shifted from the pixel position PB_A by one pixel in the horizontal direction and one pixel in the vertical direction (corresponding to 0.5 pixels horizontally and vertically after ½ reduction), as an interpolation position, and can be obtained through linear interpolation from the pixels in the periphery of the pixel position PB_B (M2, M3, D1, and D2).

According to the present embodiment, a reduced-division image can be generated by interpolating pixel values on the basis of a difference from an ideal shift amount between projection images from a plurality of projectors having pixel shifting functions. As a result, in pixel shifting control used in multi-screen projection, it is possible to achieve both an increase in resolution through pixel shifting and a reduction in jaggies.

### Third Embodiment

A third embodiment will be described next.

The third embodiment describes an example in which a captured image of a projection plane is stored in the cloud on the Internet, and the “input image” and “projection images” are distributed over the Internet.

The following descriptions will focus upon the differences from the first embodiment.

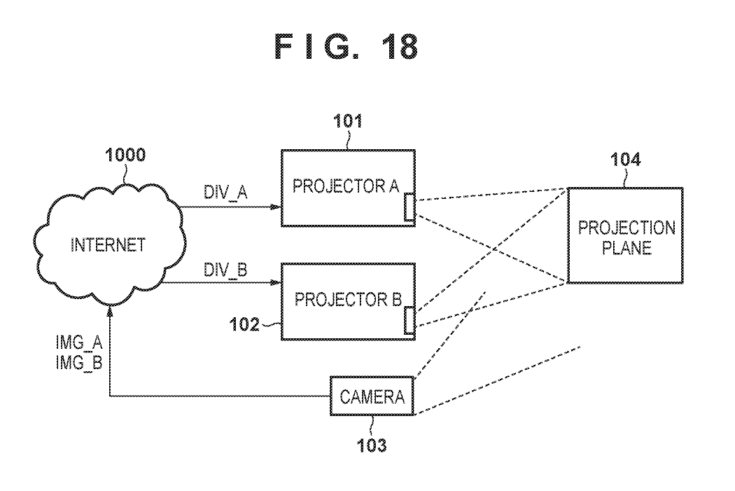

First, a system configuration according to the third embodiment will be described with reference to FIG. 18.

In the present embodiment, the reduced-division images DIV_A and DIV_B, in which the pixel positions are shifted by a predetermined shift amount, are generated in the cloud on a network using the captured images IMG_A and IMG_B captured by the camera 103. For example, the captured images IMG_A and IMG_B are stored in the cloud on the Internet 1000, and the reduced-division images DIV_A and DIV_B are generated in the cloud. Then, the generated reduced-division images DIV_A and DIV_B are delivered to the projectors A101 and B102 over the Internet 1000, which means that the PC 100, which generates the reduced-division images in the first embodiment, is not needed. In other words, it can be said that the functions of the projection control apparatus (PC) according to the first embodiment are implemented in the cloud, and the input unit 207 and the communication units 206a and 206b are connected to the camera 103, the projectors A101 and B102, and so on over the network.

According to the present embodiment, the reduced-division images DIV_A and DIV_B, in which the pixel positions are shifted by a predetermined shift amount, are generated in the cloud on a network using the captured images IMG_A and IMG_B captured by the camera 103. As a result, in pixel shifting control used in multi-screen projection, it is possible to achieve both an increase in resolution through pixel shifting and a reduction in jaggies without using a PC.

### Fourth Embodiment

A fourth embodiment will be described next.

In the above-described first and second embodiments, the filter coefficient used in the pixel interpolation when generating the reduced-division images is uniform throughout the screen, resulting in a trade-off between a loss of information and a drop in luminance arising in cases where the filter coefficient is made steep (sharp) and where the filter coefficient is made gentle.

The fourth embodiment describes an example in which the reduced-division images are generated by referring to the luminosities of the interpolated pixels when generating the reduced-division images in order to eliminate such a trade-off.

The following descriptions will focus upon the differences from the first embodiment.

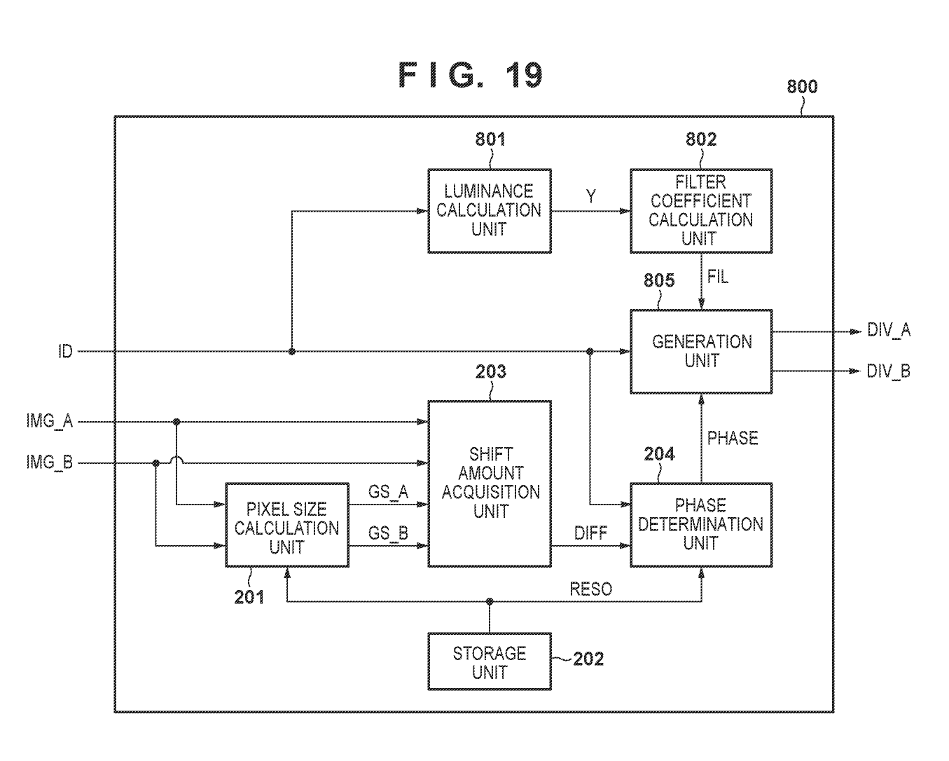

The configuration and functions of a PC 800 according to the fourth embodiment will be described next with reference to FIG. 19. The PC 800 includes a luminance calculation unit 801 and a filter coefficient calculation unit 802 in addition to the elements of the PC 100 illustrated in FIG. 3, and furthermore includes a generation unit 805 instead of the generation unit 205.

The luminance calculation unit 801 calculates a luminance component from the input image ID. A luminance component Y is calculated from an input RGB image through the following Expression 10.

Y=0.2126×R+0.7152×G+0.0722×B (Expression 10)

Although Expression 10 indicates an example of a formula based on the ITU-R BT.709 standard as one example, the formula is not limited thereto, and may be determined as appropriate in accordance with the input image.

The filter coefficient calculation unit 802 calculates a filter coefficient FIL, used in pixel interpolation by the generation unit 805, on the basis of the luminance component Y calculated by the luminance calculation unit 801.

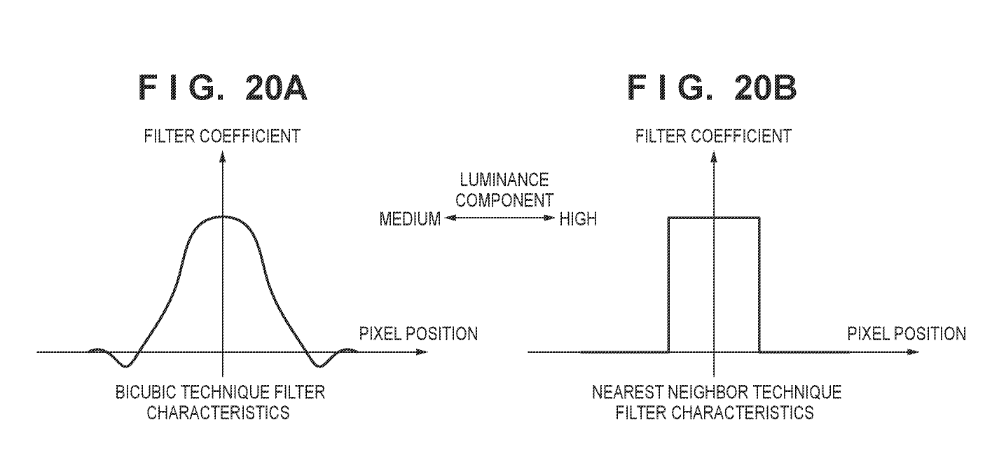

In the present embodiment, control is carried out so that the filter characteristics are steeper (sharper) the higher the luminance component Y is. FIGS. 20A and 20B illustrate examples of the filter characteristics. FIG. 20A indicates a filter coefficient for a bicubic technique, whereas FIG. 20B indicates a filter coefficient for a nearest-neighbor technique. If the interpolation is carried out using the bicubic technique as indicated in FIG. 20A, the interpolation processing will use values from adjacent pixels in the periphery, and thus the edges of the image will be slightly blurred. The peak luminance also tends to drop more easily due to the filter shape. As a result, the peak luminance will drop in cases such as when a single pixel is lit. On the other hand, the adjacent pixels in the periphery are used when generating the reduced-division images, which results in little information loss from the input image ID.

As opposed to this, if the interpolation is carried out using the nearest-neighbor technique as indicated in FIG. 20B, the filter characteristics are steeper (sharper) than when using the bicubic technique, which makes it easier to leave the edge information after interpolation and therefore results in little blurriness in the edges. Furthermore, there tends to be less of a drop in luminance than with the bicubic technique, due to the filter shape. However, the adjacent pixels are not referred to when generating the reduced-division images, and thus more information is lost from the input image ID.

Thus by optimizing the filter coefficient for each region on the basis of the luminance component Y of the input image ID, a drop in the luminance can be appropriately suppressed in the reduced-division images, and a loss of information caused by the reduction can also be suppressed.

The generation unit 805 generates the reduced-division images DIV_A and DIV_B using the input image ID, the reduced sampling phase PHASE calculated by the phase determination unit 204, and the filter coefficient FIL calculated by the filter coefficient calculation unit 802.

According to the present embodiment, the filter coefficient used in pixel interpolation when generating the reduced-division images can be controlled in accordance with a luminance component of the input image. As a result, in pixel shifting control used in multi-screen projection, it is possible to achieve both an increase in resolution through pixel shifting and a reduction in j aggies while at the same time preventing a drop in luminance.

### Other Embodiments

Embodiments of the invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-002960, filed Jan. 11, 2018 which is hereby incorporated by reference herein in its entirety.

What is claimed is:

1. A projection control apparatus comprising:
a first communication unit configured to communicate with a first projection apparatus;
a second communication unit configured to communicate with a second projection apparatus; and
at least one processor and/or at least one circuit to perform the operations of the following units:
an acquisition unit configured to acquire a shift amount between a projection position of the first projection apparatus and a projection position of the second projection apparatus; and
a generation unit configured to generate image data to be output to the first projection apparatus and image data to be output to the second projection apparatus from input image data, on the basis of the shift amount.

2. The projection control apparatus according to claim 1,
wherein the generation unit generates the respective instances of image data by sampling the input image data at a phase corresponding to the respective projection devices.

3. The projection control apparatus according to claim 1,
wherein the generation unit generates the image data to be output to the second projection apparatus by applying filtering processing to the input image data on the basis of the shift amount.

4. The projection control apparatus according to claim 3,
wherein the generation unit determines a filter coefficient to apply to the filtering processing in accordance with a luminance of the input image data.

5. The projection control apparatus according to claim 4,
wherein the generation unit determines the filter coefficient so that the filter coefficient applied to the filtering processing becomes steep when the luminance of the input image data is high.

6. The projection control apparatus according to claim 1,
wherein the first communication unit and the second communication unit communicate with the first projection apparatus and the second projection apparatus over the Internet.

7. The projection control apparatus according to claim 1, further comprising:
a third communication unit configured to communicate with an image capture apparatus that captures a first captured image by capturing a first projection image projected by the first projection apparatus and captures a second captured image by capturing a second projection image projected by the second projection apparatus,
wherein the acquisition unit acquires the shift amount on the basis of the first captured image and the second captured image.

8. The projection control apparatus according to claim 1,
wherein the generation unit generates the respective instances of image data so that an image projected by the first projection apparatus and an image projected by the second projection apparatus overlap on a projection plane and an image is displayed at a higher resolution than the resolutions of the respective images.

9. A projection system comprising:
a first projection apparatus;
a second projection apparatus; and
a control apparatus,
wherein the control apparatus includes:
a first communication unit configured to communicate with the first projection apparatus;
a second communication unit configured to communicate with the second projection apparatus; and
at least one processor and/or at least one circuit to perform the operations of the following units:
an acquisition unit configured to acquire a shift amount between a projection position of the first projection apparatus and a projection position of the second projection apparatus; and
a generation unit configured to generate image data to be output to the first projection apparatus and image data to be output to the second projection apparatus from input image data, on the basis of the shift amount.

10. A projection control method of a projection control apparatus comprising a first communication unit configured to communicate with a first projection apparatus and a second communication unit configured to communicate with a second projection apparatus, the method comprising:
acquiring a shift amount between a projection position of the first projection apparatus and a projection position of the second projection apparatus; and
generating image data to be output to the first projection apparatus and image data to be output to the second projection apparatus from input image data, on the basis of the shift amount.

11. The projection control method according to claim 10,
wherein in the generating, the respective instances of image data are generated by sampling the input image data at a phase corresponding to the respective projection devices.

12. The projection control method according to claim 10,
wherein in the generating, the image data to be output to the second projection apparatus is generated by applying filtering processing to the input image data on the basis of the shift amount.

13. The projection control method according to claim 12,
wherein in the generating, a filter coefficient to apply to the filtering processing is determined in accordance with a luminance of the input image data.

14. The projection control method according to claim 13,
wherein in the generating, the filter coefficient is determined so that the filter coefficient applied to the filtering processing becomes steep when the luminance of the input image data is high.

15. The projection control method according to claim 10,
wherein the first communication unit and the second communication unit communicate with the first projection apparatus and the second projection apparatus over the Internet.

16. The projection control method according to claim 10,
wherein the projection control apparatus further comprises a third communication unit configured to communicate with an image capture apparatus that captures a first captured image by capturing a first projection image projected by the first projection apparatus and captures a second captured image by capturing a second projection image projected by the second projection apparatus,
wherein in the acquiring, the shift amount is acquired on the basis of the first captured image and the second captured image.

17. The projection control method according to claim 10,
wherein in the generating, the respective instances of image data are generated so that an image projected by the first projection apparatus and an image projected by the second projection apparatus overlap on a projection plane and an image is displayed at a higher resolution than the resolutions of the respective images.

18. A non-transitory computer-readable storage medium storing a program for causing a computer to execute a projection control method of a projection control apparatus, the apparatus comprising a first communication unit configured to communicate with a first projection apparatus and a second communication unit configured to communicate with a second projection apparatus, and the method comprising:
acquiring a shift amount between a projection position of the first projection apparatus and a projection position of the second projection apparatus; and
generating image data to be output to the first projection apparatus and image data to be output to the second projection apparatus from input image data, on the basis of the shift amount.
